(19) United States
(12) Patent Application Publication
(10) Pub. No.: US 2026/0109317 A1
(43) Pub. Date: Apr. 23, 2026

(54) ANTI-THEFT VEHICLE PEDAL LOCKING DEVICE

(71) Applicant: MATSCITECHNO LICENSING COMPANY, KENNETT SQUARE, PA (US)

(72) Inventor: Robert A. Vito, Kennett Square, PA (US)

(21) Appl. No.: 19/364,104

(22) Filed: Oct. 21, 2025

Related U.S. Application Data
(60) Provisional application No. 63/709,780, filed on Oct. 21, 2024.

(51) Int. Cl. B60R 25/00; B60R 25/22; B60R 25/23

(52) U.S. Cl. CPC B60R 25/005; B60R 25/225; B60R 25/23

(57) ABSTRACT

A device for locking the brake or clutch of a vehicle and thereby preventing the theft of the vehicle. The device includes at least a base member having at least two feet for placement on the floorboard of a vehicle beneath a brake pedal; a U-shaped housing comprising a first arm attached to the base member and a second arm shorter in length than the first arm, thereby defining an opening configured to receive a brake pedal shaft through the opening and into the U-shape of the U-shaped housing; and a locking portion extendably associated with the first arm and configured to slidably extend a pin into the U-shape incrementally upwardly in correspondence with the extension of the locking portion, the pin having mounted thereto and axially parallel thereto an additional foot, to thereby lock an underside of the brake pedal shaft with the pin and a brake pedal associated with the shaft with the additional foot such that a brake pedal cannot be depressed.

### CROSS-REFERENCE TO RELATED APPLICATIONS

This application claims priority to U.S. Provisional Application No. 63/709,780, filed on Oct. 21, 2024, incorporated herein by reference in its entirety.

### BACKGROUND

### Field of the Disclosure

This disclosure relates generally to vehicle theft prevention, and more particularly to a device which prevents a vehicle pedal, such as the brake or clutch pedal, from being depressed, thereby rendering a vehicle inoperable to prevent theft.

### Description of the Background

Automotive theft is a significant worldwide issue. In 2023 alone, estimates indicate that a vehicle was stolen in the United States every 31 seconds, or about three vehicle thefts per 1,000 U.S. residents. This represents a 41% increase in vehicle thefts since 2019.

The increasing frequency of thefts of motor vehicles has resulted in the availability of different types of mechanical anti-theft devices. One type of prior art system mechanically locks the brake and accelerator by means of two independent or articulated shoes which lock the pedals. The major problem stemming from the use of such devices is that the driver has to reach out for the pedal area or actually get down on his or her knees in order to operate the locking device, and the varying distance between the brake and accelerator can prevent the device from being installed.

More recently, some devices are constructed from a long rod consisting of an anti-picking material which is provided at both ends, with two shaped members that couple respectively with a pedal and with the steering wheel of the vehicle. The coupling with the steering wheel is locked using a safety lock that prevents the same from being disengaged. This device can be employed on so-called manual transmission cars as well as on automatic transmission vehicles, but does suffer from significant drawbacks.

First, due to the significant length and consequent cumbersomeness, this device is difficult to store when the device is not being utilized. Secondly, devices of this type have a poor record against theft, as it is relatively easy to cut the rim of the steering wheel by means of a saw or the like, and the anti-theft device can then be disengaged merely pulling apart the two ends of the steering rim.

Numerous other “active” devices must be actively placed on a vehicle and suffer variously from invasive (to the vehicle) installation, cumbersome installation on hands and knees or at odd angles, and/or inconvenient sizing for placement and storage. Passive alarms have also continued to gain in popularity, but these devices are expensive and may activate when a vehicle is accidentally struck or touched, when a vehicle battery fails, or when a user sits in the vehicle without moving for a substantial period of time, and are often far more simple to disarm than the general public appreciates. Further, many automobiles built since 1990 cannot be started or be placed into gear without the brake or clutch pedal being depressed, but most security devices do not prevent depression of these pedals and thus cannot prevent the vehicle starting.

Other anti-theft efforts include complex vehicle tracking devices which send out signals to police if a vehicle is reported stolen. The subsequent police search may take up to 24 hours or longer with no guarantee of recovery. Installation of these systems is expensive, and often requires a periodic monitoring fee.

Many of the foregoing drawbacks of the known art were addressed by the approach taken in, among others, U.S. Pat. Nos. RE38951, RE39248, 6,192,724, and 6,089,055, to Vito. This approach solved many of the drawbacks and disadvantages inherent in the prior known efforts. However, although this approach envisioned the use of a single foot, or multiple cleats, to be placed against the floor of the vehicle to provide vehicle security, the rocking back and forth and side to side of such a device against the floor may still allow sufficient shifting of the device so as to allow for displacement from a secure position.

The need thus exists for a brake or clutch lock mechanism which does not require the driver or vehicle operator to get down on his/her knees, to act invasively to a vehicle, and which cannot be removed or disabled by rocking back and forth, and side to side.

### SUMMARY

The embodiments include a device, system and method for locking a pedal of a vehicle to thereby prevent theft thereof. Included may be: a base member having at least two distally located stabilizing feet on an underside thereof, the base member being positionable on a floorboard of the vehicle beneath the pedal; a U-shaped housing comprising two arms, a first of the two arms comprising an open cylinder attached to said base member and including a slot on a side thereof facing a second of the two arms, the second arm being shorter than said first arm and being unattached to the base member so as to define an opening for receiving at least a portion of the pedal; an extendable inner arm slidably fitted in the open cylinder of the first arm and including a locking pin at a base portion thereof, the locking pin being seated in the base member prior to extension of the extendable inner arm and sliding upwardly along the slot upon extension of the extendable inner arm; and a lock associated with said first arm capable of locking the extendable inner arm such that the pin is pressed against a pedal underside of the pedal so as to prevent depression of the pedal. The stabilizing feet may then impede movement of the second arm so as to reposition the opening into alignment with the pedal after the locking.

Included in additional embodiments may be: a base member having a length longer than its width, positionable against a floor of the vehicle beneath the brake or the clutch at least on a shaft thereof; a plurality of feet on an underside of the base member extending longitudinally equally on either side of the width of the base member, at least two of the feet being distal from one another along the length of the base member; a metallic U-shaped housing comprising a first arm attached at a top side of the base member and having a slot longitudinally therethrough facing a second arm, the second arm being attached to the first arm distally from the base member, extending downward from the attachment, and being unconnected to the base member so as to provide an opening into the U-shaped housing at an endpoint of the second arm, the opening being configured to receive the shaft; a rod slidably within the first arm and having a locking pin at an end thereof, the rod being extendable upward and downward within the first arm such that the locking pin extends outwardly from the slot during extension of the first arm; and a lock proximate the attachment, wherein actuation of the lock locks the rod in a position such that the pin firmly abuts the shaft, and such that the feet are stabilized firmly against a floor of the vehicle, so as to prevent depression of the brake or clutch.

Also included may be: a base member being positionable on a floorboard of the vehicle beneath the pedal; at least three stabilizing feet mounted to the base member, at least two of the feet being distally located from one another on an underside of the base member and in contact with the floorboard, and a third of the feet being substantially equidistant between the first and second feet along the base member; a U-shaped housing comprising two arms, a first of the arms comprising an open cylinder attached to said base member and including a slot on a side thereof facing a second of the arms, the second arm being shorter than said first arm and being unattached to the base member so as to define an opening for receiving at least a portion of the pedal; an extendable inner arm slidably fitted in the open cylinder of the first arm and including a locking pin at a base portion thereof, the locking pin being seated in the base member prior to extension of the extendable inner arm and sliding upwardly along the slot upon extension of the extendable inner arm; and a lock associated with said first arm capable of locking the extendable inner arm such that the pin is pressed against a pedal underside of the pedal so as to prevent depression of the pedal. The stabilizing feet may impede moving of the second arm so as to reposition the opening into alignment with the pedal after the locking.

Yet further included may be: a base member having at least two feet for placement on the floorboard of a vehicle beneath a brake pedal; a U-shaped housing comprising a first arm attached to the base member and a second arm shorter in length than the first arm, thereby defining an opening configured to receive a brake pedal shaft through the opening and into the U-shape of the U-shaped housing; and a locking portion extendably associated with the first arm and configured to slidably extend a pin into the U-shape incrementally upwardly in correspondence with the extension of the locking portion, the pin having mounted thereto and axially parallel thereto an additional foot, to thereby lock an underside of the brake pedal shaft with the pin and a brake pedal associated with the shaft with the additional foot such that the brake pedal and shaft cannot be depressed.

The disclosed embodiments thus provide a brake or clutch lock mechanism which does not require the driver or vehicle operator to get down on his/her knees, nor to act invasively to a vehicle, and which cannot be removed or disabled by rocking back and forth, or side to side.

### BRIEF DESCRIPTION OF THE FIGURES

Referring now to the figures incorporated herein, shown are non-limiting embodiments of the present disclosure, wherein like numerals represent like elements, and wherein:

FIG. 1 is an elevational view of a brake anti-theft device;

FIG. 2 is an elevational view of the handle and lock pin utilized with the brake lock mechanism of the brake anti-theft device;

FIG. 3 is an elevational view of the brake or clutch locking anti-theft device in an inactive position;

FIG. 4 is an elevational view of the brake or clutch locking anti-theft device in an activated state;

FIG. 5 is a side perspective view of an alternative embodiment of the brake or clutch locking anti-theft device;

FIG. 6 is a side perspective view of the alternative embodiment of the brake locking anti-theft device;

FIG. 7 is a perspective view of the alternative embodiment of the brake locking anti-theft device;

FIG. 8 is a perspective view of exemplary feet and prongs for the base of the brake locking anti-theft device;

FIG. 9 is a perspective view of exemplary feet and adjustable contact points for the base of the brake locking anti-theft device;

FIG. 10 is a perspective view of the alternative embodiment of the brake locking anti-theft device;

FIG. 11 is a perspective view of the alternative embodiment of the brake locking anti-theft device;

FIG. 12 is a perspective view of the alternative embodiment of the brake locking anti-theft device; and

FIG. 13 is a perspective view of an exemplary rod with a threaded portion and carriage with locking pin that may be utilized with the brake locking anti-theft device.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Exemplary embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that exemplary embodiments may be embodied in different forms. As such, the exemplary embodiments should not be construed to limit the scope of the disclosure. As referenced above, in some exemplary embodiments, well-known processes, well-known device structures, and well-known technologies may not be described in detail.

The terminology used herein is for the purpose of describing particular exemplary embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” and other like terms, are inclusive and therefore specify the presence of stated features, steps, operations, elements, and/or components, but do not preclude the presence or addition of one or more other features, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on”, “engaged to”, “associated with”, “connected to”, “coupled to” or other like terms in relation to another element or layer, it may be directly on, engaged, connected or coupled to the other element or layer, or intervening elements or layers may be present, unless clearly indicated otherwise. In contrast, when an element is referred to as being “directly on,” “directly engaged to”, “directly connected to”, “directly coupled to”, and so on in relation to another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

A brake or clutch anti-theft device is now described with reference to the enclosed Figures, wherein like numbers may or may not represent like elements. In general, the present device is specifically designed to lock the brake or clutch pedal of a motor vehicle in an “up”, i.e., a non-depressed, state.

Since 1990, many vehicles manufactured for sale in North America cannot start without the depression of the brake pedal (often termed the brake pedal shift interlock). Thereby, the disclosure may particularly prevent the brake pedal (or clutch) from being depressed, thus disabling the vehicle and preventing theft and use of the motor vehicle more advantageously than in the known art.

The disclosed embodiments may be utilized by the driver or operator from the comfort of the driver's seat of the vehicle, without any need for the driver to get down on his hands or knees or crouch in order to place or adjust the system. While the embodiments may be described in the context of a conventional automobile, it is to be appreciated that the teachings herein are equally applicable to all manner of vehicles having brake pedal arms or shafts or clutches, including cars, sports utility vehicles, vans, trucks, utility task vehicles, side-by-side vehicles, and so on, by way of non-limiting example.

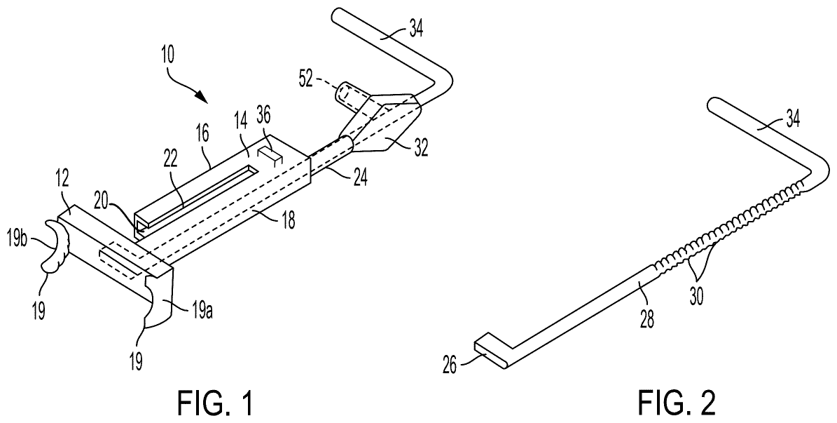

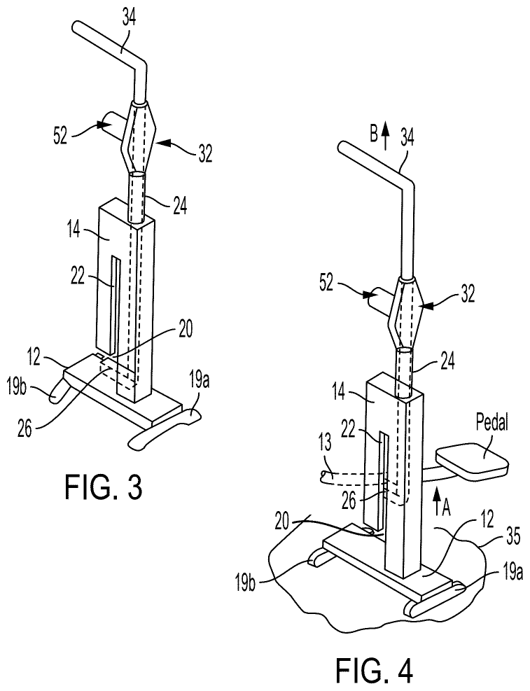

For purposes of explanation the embodiments are now described in the context of a device which locks a brake pedal in an upward position, thus, for example, disabling the vehicle. Referring now to FIGS. 1 to 4, the brake (or clutch) pedal anti-theft locking device 10 comprises a base 12 which is placed on the floor of the vehicle adjacent to the brake pedal and shaft 13. The base 12 is placed flush to the floorboard of the vehicle directly below the brake pedal and pedal shaft (arm) 13.

The base may include, situated so as to provide uniform pressure to the floor, at least two feet 19. In embodiments, the feet may or may not be equidistant from the brake pedal shaft. As such, the first foot 19a may be most proximate to the first arm 18, and the second foot 19b may be most proximate the second arm 16. Simply put, this allows first foot 19a to have imparted thereto the additional rigidity of adjacent first arm 18 as compared to second arm 16, as the second arm 16 includes a\the opening 20 for entry of the brake pedal shaft 13 up against the slot 22 within the U-shaped housing 14.

More specifically, extending from the base 12 may be U-shaped steel housing 14, the U-shape of which extends downward in the illustration. The U-shaped housing 14 comprises the two arms 16, 18. One arm 16 of the U-shaped housing 14 is shorter than the other 18, thereby defining the opening 20 through which the pedal shaft 13 may pass to gain adjacency to the slot 22. The slot 22 opens into the space between the arms 16, 18 of the U-shaped housing 14, and may preferably comprise a cutout in longer leg 18. The opening 20 facilitates the placement and removal of the brake pedal shaft 13 into the U-shape opening into the presence of the slot 22. In embodiments, the U-shaped opening may have an approximate width of a typical steel brake pedal shaft 13 such that the brake pedal shaft 13 may slide through opening 20 and upwardly into the U-shaped opening. In this position, the brake pedal may still be depressed freely.

The disclosure may further comprise a locking mechanism 32 associated with the arm 18 of the U-shaped housing 14. The arm 18 of the U-shaped housing 14 may include, for example, within an outer tube 24 provided thereby an extendable rod 28, such as a cylindrical tube or rod, designed to include at the base-adjacent end thereof a slidable locking pin 26 which is attachedly fastened to the end of an extendible rod 28 such that it extends along an axis perpendicular to the longitudinal center line of slot 22. The rod 28 may include teeth, machined lock ratchets, serrations (horizontal and/or vertical), or the like (collectively “ratchets”) 30 which extend and/or may be extended out of the outer tube 24 provided by arm 18 operationally into conjunction with the locking mechanism 32. The second end of the rod 28, distal from the base, comprises a handle or grip 34 which is used to pull the rod 28 upward and thereby extend the rod outwardly from within the outer tube 24 provided by arm 18.

The locking mechanism 32 may be any commercially available locking mechanism and include any lock type 52, such as a key-operated 52 steering wheel locking mechanism 32. Other locking mechanisms 32 may be or include combination locks 52, by way of example. Locking mechanism 32 locks the ratchets 30 at the appropriate point chosen by the user to brace device 10 such that pin 26 has been pulled upwardly, sliding along slot 22 until pressing against the underside of pedal shaft 13. The locking mechanism 32 may be configured to lock ratchets 30 to stop rod 28 from moving vertically and/or rotationally.

That is, and as shown in FIG. 4, as the rod 28 is extended upward, pin 26 enters from the base 12 and slides along the slot 22 (Arrow A) until pin 26 secures the bottom of the brake pedal shaft 13 in an upward or unpressed position so that it cannot be depressed. Once in this position, and after locking into place of pin 26 by actuation of locking mechanism 32, the brake pedal shaft cannot be depressed. Because the pedal cannot be depressed, the car may not start and the driver cannot activate the brake to stop the vehicle if it is started.

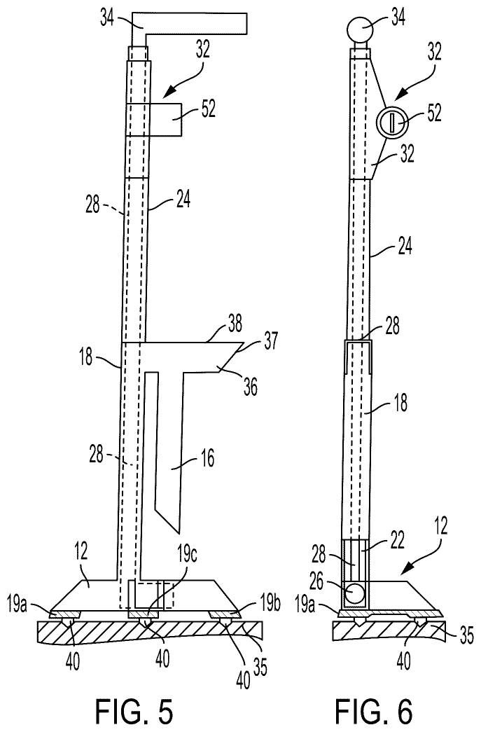

Alternative embodiments are shown in FIGS. 5 and 6. As shown in FIG. 5, the base 12 and bottom of arm 16 may be beveled an angle, such as at 45 degree angles, or rounded. so that the brake pedal shaft 13 can more easily be guided into and out of the slot 22 when the device is placed on and removed from the brake pedal shaft 13.

Pressing element(s) 36 may also be provided for enabling the driver to better press the device into the floorboard or carpet of the vehicle. In an embodiment, pressing element 36 comprises a foot rest 37 which extends horizontally from the top of arm 16. The rest 37 may provide a sufficient surface area 38 for the foot of an operator to press downward. and may, for example, include a gripping top surface.

Embodiments may further incorporate studs 40 which extend downward from the base 12 and which facilitate the positioning of the device against, and gripping of the device to, a carpeted floor. That is, studs 40 may help prevent the device from moving with respect to the floor.

In operation, the vehicle operator unlocks the device and lowers the pin 26 down in the slot 22 to the base 12 via actuation of rod 28 using the handle 34. The base 12 is then placed on the floor or floorboard 35 (see FIG. 4) under the brake pedal shaft 13. The brake pedal shaft 13 then passes through the opening 20 in the U-shaped housing 14 and into consequent adjacency with the slot 22, with the feet 19 of base 12 positioned squarely on the floorboard 35 of the vehicle. The operator then pulls up the handle 34 (Arrow B) to raise the rod/inner tube 28 and to thus raise the locking pin 26 at the end of rod 28 upwardly along the slot 22 to secure the pin 26 against the bottom of brake pedal shaft 13 while the brake pedal is in an upward position.

As shown in FIGS. 5 and 6, the operator may place his foot on extension 36 to maximize the downward thrust of the feet 19 against the floorboard 35 of the vehicle. Studs 40 may secure the device against the floorboard or carpet. The vehicle operator may then lock the device in this position using the lock mechanism 32, such that the brake pedal 13 cannot be depressed, to thereby disable the operation of the vehicle.

As referenced throughout, the base 12 may preferably include two or more feet 19 in the embodiments. These feet 19 provide stability not provided in the known art. Simply put, absent feet 19, rocking device 10 side to side, such as by using handle 34, may eventually dislodge the device sufficiently so as to allow for movement of the brake pedal shaft 13 and consequent actuation of the brake pedal.

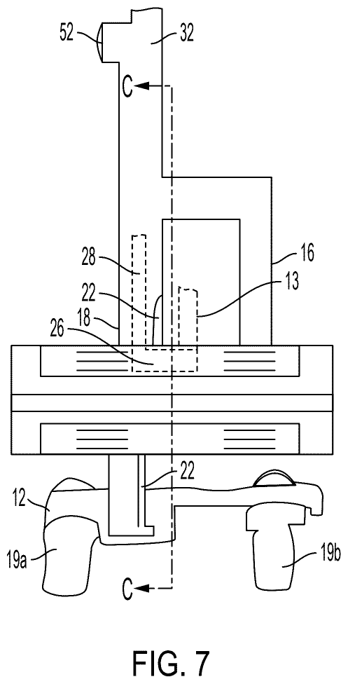

However, feet, such as illustrated in FIG. 7, may provide additional stability to base 12, such that the base cannot be rocked and consequently cannot be dislodged. As shown, the respective feet 19a, 19b may, in some cases, be approximately equidistant from the center of gravity (axis C) of the device 12, which may be slightly shifted toward arm 18 since arm 18 extends fully between handle 34 and base 12, so as to provide maximum stability. This may, in embodiments, place one foot 19a closer to rigid arm 18.

In other cases, the feet 19 may be staggered, such as being centered about rigid arm 18. This may serve to provide additional stability, at least in that the moment of inertia for any rocking may likely be centered on rigid arm 18, since it is this arm that is mechanically communicative with handle 34, from which the attempted rocking may be imparted.

Additionally, feet 19 may have a length extending beyond the front and back of base 12, or may extend in only one direction from base 12. Further, the feet 19a, b may extend by the same amount from both the front and back of base 12, or may extend unequally from the front of base 12 as compared to the back. Moreover, the widths of each foot 19a, b may similarly vary, such as in relation to the length thereof. Yet further, both feet may have the same length and width, or the comparative length or width of each foot 19a, b may differ.

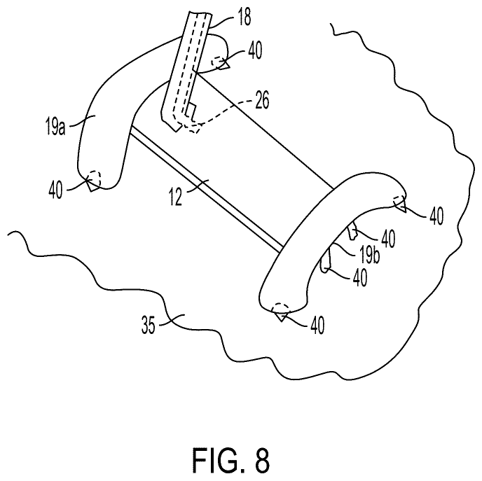

FIG. 8 illustrates the feet 19 having optional studs 40 at the bottom thereof. These studs may be placed at the corners of the underside of feet 19, centered at the underside of feet, or both so as to provide better grip to floorboard 35 and thereby enable additional stability to device 10.

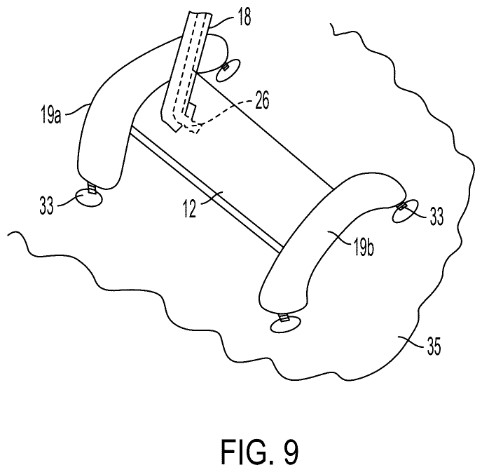

FIG. 9 shows the feet 19 of FIG. 8, with each of the feet having adjustable contact points 33, rather than the studs 40 of FIG. 8. In this exemplary embodiment, the adjustable contact points or adjustments 33 may provide variable distance of contact from feet 19 to vehicle floorboard 35. Thereby, variability in the flatness of the floorboard 35 may be accounted for by adjustments 33, so as to allow for improved stability of device 10 once it is engaged. In this way, device 10 may be customizable by the user for maximum security with respect to whatever vehicle the device 10 is attached to. The adjustments 33 may be, for example, rotating/threaded elements having a flat, such as round, base, or may have a pointed or studded base, for example to enter partially into a carpeted layer and contact a more rigid surface or floorboard 35 underneath.

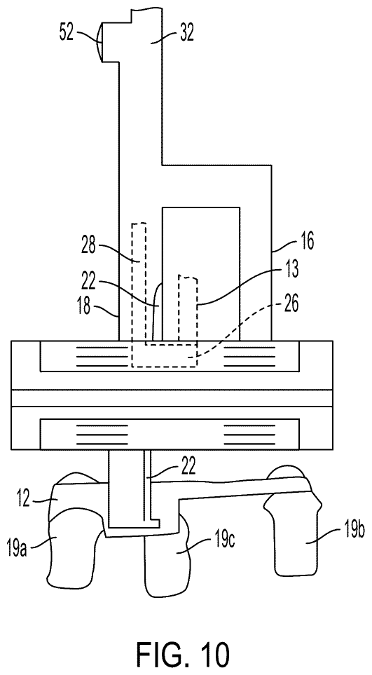

FIG. 10 illustrates an additional embodiment, in which a third foot 19c is added. As shown, the third foot 19c may vary in its length from the other feet 19a, b. Third foot 19c may provide additional stability for device 10 in a case of side-to-side rocking, and/or may provide additional stability from front to back rocking. In the later case, third foot 19c may be longer than or shorter than the outer feet 19a, b. The third foot 19c also may or may not be equidistant from the other two feet.

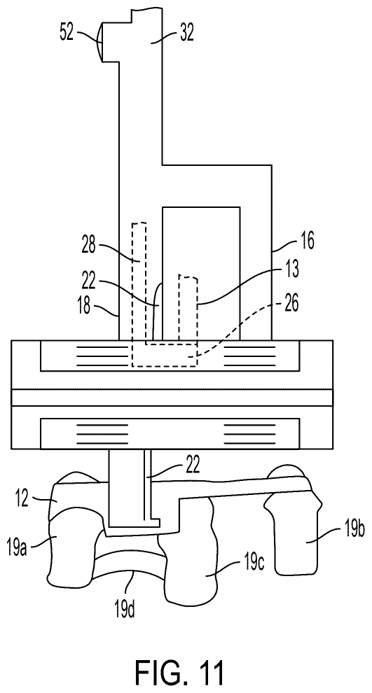

As is further shown in FIG. 11, the third foot 19c may provide a mounting point for a fourth foot 19d perpendicular to the longitudinal portion of the other feet 19a, b, c. Alternatively, the third foot 19c may not contact floor in providing a mount for fourth foot 19d, and fourth foot 19d likewise may or may not contact floor 35. That is, in some exemplary embodiments, the third and fourth feet 19c, d may solely provide additional rigidity at base 12, such as to, again, provide further stability to base 12 so as to prevent rocking and consequent incapacitation of device 10.

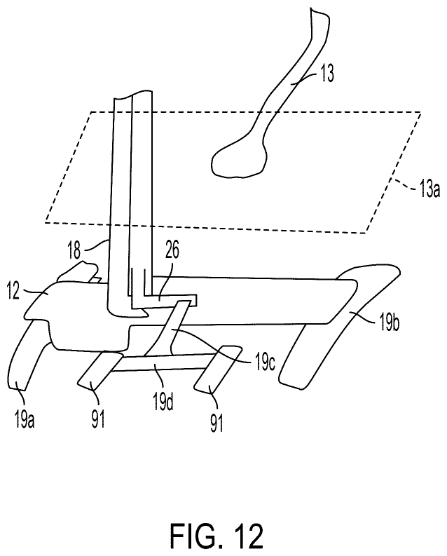

FIG. 12 shows an additional embodiment in which the third foot 19c is mounted to the locking pin 26, and again provides a mounting point for fourth foot 19d. As shown throughout, pedal may include not only pedal shaft 13, but additionally the typically rectangular steel plate or rectangular portion 13a mounted to shaft 13. In the illustrated embodiment, as locking pin 26 is raised into contact with shaft 13 to prevent downward movement thereof as discussed herein, third food 19c rises with pin 26, bringing fourth foot 19d into contact with the underside of rectangular portion 13a. As such, when locking pin 26 is locked into position to prevent downward movement of the pedal shaft 13, so too is fourth foot 19d locked into position to prevent downward movement of rectangular portion 13a.

To this end, fourth foot 19d may also have appended thereto one, two, or more contact portions 91, which may snug up against the underside of rectangular portion 13a. Accordingly, the contact portions may or may not be contoured, and may or may not be raised, in relation to the pedal underside of rectangular portion 13a, so as to improve contact with pedal underside of rectangular portion 13a when locking pin 26 is raised. Further, contact portion(s) 91 may be constructed of a conformable but dense material, or a hard material such as metal, to optimize rigidity and/or conformance to the pedal underside of rectangular portion 13a so as to prevent downward movement of the pedal. Likewise, third and fourth feet 19c, d in this embodiment may also be imparted with maximum rigidity, such as being formed of metal, so as to preclude downward movement of the pedal.

Yet further, the contact portion(s) 91 may be located so as to most suitably preclude downward pressing of the pedal when locking pin 26 is raised. By way of example, fourth foot 19d may be substantially centered on third foot 19c, and two contact portions may be placed on the outer aspects of fourth foot 19d. Alternatively and by way of non-limiting example, fourth foot 19d may extend in only one direction from third foot 19c, and in such a case may have contact portions 91 directly above third foot 19c, and at a distal end of fourth foot 19d.

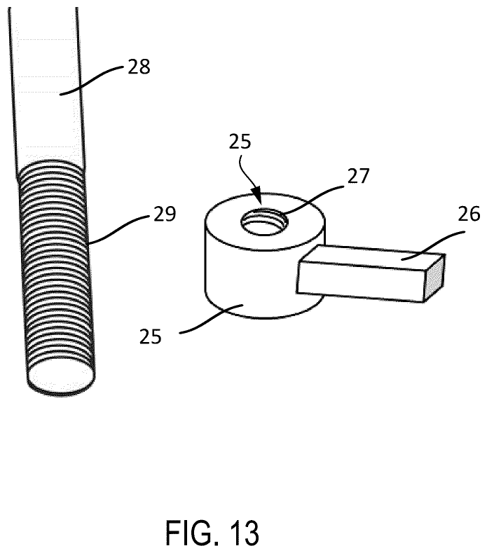

FIG. 13 shows an additional embodiment of a rod 28 that is configured to rotate within the first arm 18 to move or translate the slidable locking pin 26 via a carriage 25. In embodiments, the rod 28 comprises a threaded portion 29 on a portion of the rod opposite to the handle or grip 34. In embodiments, the carriage 25 comprises a central opening 25 with threads 27 sized and configured to threadingly engage threaded portion 29 of rod 28. It should be appreciated that in this embodiment, the carriage 25 is configured to fit within, and be slidably retained by the cutout or internal hollow structure of first arm 18, and the locking pin 26 extends out laterally from first arm 18 into slot 22. The rotation of rod 28 causes the carriage 25 (and locking pin 26) to move up and down relative to the U-shaped housing 14 and slot 22, and lock the pedal shaft 13 in place with a twisting motion of handle or grip 34. In embodiments, the rod 28 further comprises retaining means to prevent translational movement of the rod 28 relative to first arm 18, such as a tongue and groove, a bearing, a circumferential key and slot, or the like, positioned on rod 28 and on an interior portion of first arm 18 and/or outer tube 24 (not shown).

In embodiments, the rod 28 may be also configured to rotate and translate (e.g., slide or extend) to adjust locking pin 26 to the activated state, or may be configured to only rotate as described above. In the embodiment wherein the rod 28 is configured to rotate and translate, the translation or extending described in previous embodiments can be used for large adjustments, followed by rotation of rod 28 for finer adjustments. The rotation provides precise control of the positioning of locking pin 26, and can be used to firmly set the device 100 and apply a suitable upward force on pedal shaft 13. Further it should be appreciated that in this embodiment the locking mechanism 32 associated with the arm 18 would arrest both the translation and rotation of rod 28 to lock rod 28 and locking pin 26 securely against pedal shaft 13. In embodiments, the locking mechanism 32 ratchets in steps for both the translation and rotation of rod 28, meaning as rod 28 is pulled up with the handle or grip 34, the vertical position is locked incrementally higher and is prevented from lowering, followed by an incremental locking of the twisting or rotation of rod 28 to increase the tightening of pin 26 against pedal shaft 13. In embodiments, the locking of rod 28 is stepped, wherein the rod 28 is first locked to translational movement and second locked to rotational movement.

It is to be appreciated by those skilled in the art that the device of the present disclosure may include a protective outer coating composed of vinyl, PTFE, rubber or plastic. Similarly, the disclosed components may be formed of any known composition so as to provide the requisite rigidity, such as plastic, composite, metal, and so on.

The device of the present disclosure has been described in the context of locking the brake of a vehicle. In standard transmission vehicles, the device may alternatively be affixed to the clutch of the vehicle, as discussed above. Because the clutch is then locked in an upward position and cannot be depressed, the vehicle cannot be started and/or operated. Accordingly, the teachings of the device of the present disclosure may be equally applicable to affixation to a clutch in a standard transmission vehicle.

The device of the present disclosure has been described with reference to selected exemplary embodiments. It is to be appreciated that other embodiments fulfill the spirit and scope of the disclosure and that the true nature and scope of the embodiments are to be determined with reference to the claims appended hereto.

What is claimed is:

1. A device for locking a pedal of a vehicle to thereby prevent theft thereof, comprising:
a base member having at least two distally located stabilizing feet on an underside thereof, the base member being positionable on a floorboard of the vehicle beneath the pedal;
a U-shaped housing comprising two arms, a first of the two arms comprising an open cylinder attached to said base member and including a slot on a side thereof facing a second of the two arms, the second arm being shorter than said first arm and being unattached to the base member so as to define an opening for receiving at least a portion of the pedal;
an extendable inner arm slidably fitted in the open cylinder of the first arm and including a locking pin at a base portion thereof, the locking pin being seated in the base member prior to extension of the extendable inner arm and sliding upwardly along the slot upon extension of the extendable inner arm;
a third foot connective with the locking pin, and a fourth foot upon the third foot and running axially perpendicular to the third foot; and
a lock associated with said first arm capable of locking the extendable inner arm once the locking pin is pressed against a shaft of the pedal and the fourth foot is pressed against a pedal underside of the pedal, so as to prevent depression of the pedal;
wherein the stabilizing feet impede movement of the second arm so as to reposition the opening into alignment with the pedal after the locking.

2. The device of claim 1, wherein said lock is activated by a key.

3. The device of claim 1, wherein said lock is activated by a combination.

4. The device of claim 1, wherein the portion of the pedal is the shaft.

5. The device of claim 1, wherein the pedal is a brake pedal.

6. The device of claim 1, wherein the pedal is a clutch pedal.

7. A device for locking the brake or clutch of a vehicle and thus preventing its theft, comprising:
a base member having a length longer than its width, positionable against a floor of the vehicle beneath the brake or the clutch at least on a shaft thereof;
a plurality of feet on an underside of the base member extending longitudinally equally on either side of the width of the base member, at least two of the feet being distal from one another along the length of the base member;
a metallic U-shaped housing comprising a first arm attached at a top side of the base member and having a slot longitudinally therethrough facing a second arm, the second arm being attached to the first arm distally from the base member, extending downward from the attachment, and being unconnected to the base member so as to provide an opening into the U-shaped housing at an endpoint of the second arm, the opening being configured to receive the shaft;
a rod slidably within the first arm and having a locking pin at an end thereof, the rod being extendable upward and downward within the first arm such that the locking pin extends outwardly from the slot during extension of the first arm; and
a lock proximate the attachment, wherein actuation of the lock locks the rod in a position such that the pin firmly abuts the shaft, and such that the feet are stabilized firmly against a floor of the vehicle, so as to prevent depression of the brake or clutch.

8. The device of claim 7, wherein the feet include at least two height adjustments facing the floor.

9. The device of claim 8, wherein the at least two height adjustments are rotatable for extension thereof.

10. The device of claim 9, wherein the at least two height adjustments are threaded.

11. The device of claim 7, wherein said lock is actuated by a key.

12. The device of claim 7, wherein said lock is actuated by a combination.

13. A device for locking a pedal of a vehicle to thereby prevent theft thereof, comprising:
a base member being positionable on a floorboard of the vehicle beneath the pedal;
at least three stabilizing feet mounted to the base member, at least two of the feet being distally located from one another on an underside of the base member and in contact with the floorboard, and a third of the feet being substantially equidistant between the first and second feet along the base member;
a U-shaped housing comprising two arms, a first of the arms comprising an open cylinder attached to said base member and including a slot on a side thereof facing a second of the arms, the second arm being shorter than said first arm and being unattached to the base member so as to define an opening for receiving at least a portion of the pedal;
an extendable inner arm slidably fitted in the open cylinder of the first arm and including a locking pin at a base portion thereof, the locking pin being seated in the base member prior to extension of the extendable inner arm and sliding upwardly along the slot upon extension of the extendable inner arm; and
a lock associated with said first arm capable of locking the extendable inner arm such that the pin is pressed against a pedal underside of the pedal so as to prevent depression of the pedal;
wherein the stabilizing feet impede moving of the second arm so as to reposition the opening into alignment with the pedal after the locking.

14. The device of claim 13, the third of the feet also contacting the floorboard.

15. The device of claim 13, the third of the feet not contacting the floorboard, and further comprising a fourth of the feet extending between the first of the feet and the third of the feet.

16. The device of claim 15, the fourth of the feet contacting the floorboard.

17. The device of claim 13, wherein the first and second of the feet extend from the base member in only one direction from a width of the base member.

18. The device of claim 13, wherein the first and second of the feet extend from the base member in both directions from a width of the base member.

19. The device of claim 13, wherein each of the feet comprises gripping studs at a contact point with the floorboard.

20. The device of claim 13, wherein each of the feet comprises an adjustment to increase a contact pressure with the floorboard upon the locking.
